(19) United States
(12) Patent Application Publication
(10) Pub. No.: US 2003/0023397 A1
(43) Pub. Date: Jan. 30, 2003

(54) Portable, digital storage-tank measurement device

(76) Inventors: Timothy Parlor SR., Decatur, GA (US); Thornton Jones, Decatur, GA (US)

Correspondence Address: Myers & Associates, Intellectual Property Law, P.C, Building 3, Suite 200, 1827 Powers Ferry Road, Atlanta, GA, 30339, US

(21) Appl. No.: 09/915,839

(22) Filed: Jul. 26, 2001

(51) Int. Cl. G06F 15/00

(52) U.S. Cl. 702/127

(57) ABSTRACT

A portable, digital dipstick-style measurement and analysis system wherein an onboard portable, battery powered computer module is physically and communicatively linked to an elongated measurement rod for collecting data on stored liquid fuel and vapors, wherein collection of data is either user-controlled or sensor activated, wherein user-selectable analysis functions are performed by the computer module and wherein data and analysis reports are printed and/or digitally stored on a portable data transport such as, for exemplary purposes only, floppy disk, CD or tape.

### TECHNICAL FIELD

The present invention relates generally to measurement devices and, more specifically, to a dipstick-style tank measurement device having onboard sensor activator and computer enabling electronic measurement and analysis of tank contents with printed reporting of results and digital storage of portable data files. The present invention is particularly useful in, although not strictly limited to, fuel tank applications wherein an individual desires a portable, digital measurement and analysis instrument for testing stored liquid fuel and vapors.

### BACKGROUND OF THE INVENTION

Fuel tanks of all types require periodic evaluation, including those tanks in truck rigs and seagoing vessels. Moreover, environmental, safety and economic concerns necessitate testing of underground fuel storage tanks at regular intervals. Testing parameters of interest are numerous and include, for example, liquid volume, temperature, vapor pressure, sulfur content, octane number, density and vapor liquid ratio. As a result, fuel tank measurement devices are well known however, in view of the present invention herein described, are disadvantageous.

For instance, one type of device is permanently mounted in a fuel tank of interest and utilizes sonar to monitor liquid level, temperature, density and other physical properties. However, the measured parameters are disadvantageously limited to those that are a function of the transmission of sonic waves through liquid. Another permanently affixed device utilizes a float apparatus on an elongated probe in combination with infrared transmission and detection methods, thus avoiding the limitations of sonar. Nevertheless, the permanently fixed location of each of these versions necessitates purchase of a specific instrument for each tank to be monitored, wherein the devices are incapable of portability between tanks.

Portable measurement devices have also been proposed. One type is a stick utilizing a series of temperature sensitive variable resistors to analyze temperature and changes in liquid volume within a tank. Such a stick however, is not truly portable, wherein connection to a power source is required. Another type of stick device that does not rely on an external power source utilizes optical principles to determine and report liquid levels in a tank. The data generated by this type of device is disadvantageously limited to that expressed by a series of indicator bulbs specifically limited to and corresponding with the level of liquid measured. This limitation holds true for other portable versions, such as a device with a flexible floating cord and a sinker weight, wherein sensors are limited to providing data on liquid level.

Fuel tank measurement devices are available that are capable of collecting and analyzing more complex sets of data, but require wiring to a host computer and fixed positioning within a tank. Recognizing that true portability is desirable, some devices claim to be portable as a result of a lack of hard wiring to a host. While this does enable a user to utilize such a device to measure and monitor one fuel tank and then another, each presently available device disadvantageously requires at least temporary mounting to each fuel tank. Wherein a fuel tank does not have the proper fitting to mate with these types of devices, they cannot be utilized.

Moreover, unlike the hard-wired types, these devices do not enable a user to save data for further, more complex analysis and tracking. Some available tank monitoring systems rely upon telecommunication for transmission of data to a host. Wherein electrical power and telephone communication are cut-off, so is the ability of the tank monitoring system. This sole reliance on electrical power and telephone is disadvantageous considering periods wherein increased monitoring of underground storage tanks are likely, such as in the wake of a natural disaster, an event also likely to destroy utilities.

Therefore, it is readily apparent that there is a need for a fuel storage tank measurement apparatus having a truly portable measurement, analysis instrument enabling reporting on the contents and ground level vapors of any type of fuel container without mounting thereto, wherein digital data analysis takes place on-board and wherein data can be reported in printed form, digitally stored in a portable data file, and/or wirelessly communicated to a remote location, thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a dipstick-style tank measurement device having onboard sensor activator and computer enabling electronic measurement and analysis of tank contents with printed reporting of results and digital storage of portable data files.

According to its major aspects and broadly stated, the present invention is a portable, digital measurement and analysis system wherein a portable computer module is physically and communicatively linked to a dipstick-style instrument for collecting data on stored liquid fuel, wherein collection of data is either user-controlled or sensor activated, wherein tank specifications are selectably retrieved from a portable data storage module, wherein user-selectable analysis functions are performed by the computer module or a peripheral instrument and wherein data and analysis reports are printed, wirelessly communicated and/or digitally stored on a portable data transport such as, for exemplary purposes only, floppy disk, CD or tape.

More specifically, the present invention is a dipstick-style fuel tank measuring device having an elongated rod, wherein fluid level measurement is performed via internal ball floats and is directly readable through the transparent fiberglass casing of the elongated rod. A pressure-sensitive activation mechanism is located at the distal end, or base, of the rod, wherein electronic measurement functions and sample collection can be initiated via depression thereof. Inlet valves are provided, thereby enabling liquid sample collection. A connector port is located at the proximate end, or top, of the rod, whereby a portable computer unit is connected therewith and data is transmitted thereto.

The portable computer unit has a detachable printer for user selectable printing of fuel measurement and analysis reports, a liquid crystal display window for displaying instructions and results, a data storage and transfer device such as, for exemplary purposes only, a floppy or CD disk drive or memory card slot, a rechargeable battery, and at least one USB port for connecting and communicating with peripheral devices such as a vapor analysis instrument for ground level vapor detection and an infrared fuel analysis instrument for fuel characterization.

The portable computer unit keypad preferably includes a full function calculator with mathematical function keys, a clock and timer, an on/off switch, fuel selection keys for gasoline types and grades, fuel selection keys for diesel and kerosene, tank information keys for inputting size and dimensions thereof or for selectively retrieving such data from a portable data storage module, keys for selecting display of analysis results for HT (height), water content, temperature, ullage (amount by which a container falls short of being full), octane, sulfur content and RVP (Reid vapor pressure), and a function selection key for alternate function key operation.

Wherein tank analysis is desired, the elongated measuring rod is substantially submerged inside of the selected fuel tank with the pressure sensitive activation foot depressed by the tank bottom and the connector port accessible to the user. The volume of liquid in the tank may be read directly from the illuminated display on the measuring rod, or the user may rely on a series of prompts from the LCD window, directly inputting tank dimensions or retrieving specific tank data from portable data storage module, selecting the fuel type to be analyzed, wherein the unit can detect and report volume, temperature, water content and ullage, wherein the unit can report peripheral instrument analysis results for vapor pressure and octane, and wherein a function selection key enables user-programming for alternate function key operation and additional data analysis. A user may print results, may store the results on a portable, digital storage unit for subsequent analysis at another location, or may wirelessly communicate the results with a remote data receiver.

A feature and advantage of the present invention is the ability of such a device to provide quick and easy analysis of fuel tank contents by one individual.

A feature and advantage of the present invention is the ability of such a device to be easily transported and utilized for analysis of any tank.

A feature and advantage of the present invention is the ability of such a device to automatically activate for collection and measurement of fuel tank contents.

A feature and advantage of the present invention is the ability of such a device to enable portable, independently functioning computerized measurement and analysis of tank contents with printed reporting of results.

A feature and advantage of the present invention is the ability of such a device to enable portable, independently functioning computerized measurement and analysis of tank contents with digital storage of portable data files.

A feature and advantage of the present invention is the ability of such a device to provide portable, digital measurement and analysis for testing stored liquid fuel.

A feature and advantage of the present invention is the ability of the present invention to enable reporting on the contents of any type of fuel container without mounting thereto.

A feature and advantage of the present invention is the ability to collect, analyze and report on the liquid contents of a storage tank while utilizing portable battery power.

A feature and advantage of the present invention is the ability of such a device to digitally store data and analysis reports on a portable data transport such as, for exemplary purposes only, floppy disk, CD or tape.

A feature and advantage of the present invention is the ability of such a device to utilize a portable data module to specify individual tank parameters for a plurality of storage tanks, thereby eliminating the need for user entry thereof.

A feature and advantage of the present invention is the ability of such a device to enable direct fluid level reporting on a dipstick-style rod.

A feature and advantage of the present invention is the ability of such a device to provide a pressure-sensitive activation mechanism.

A feature and advantage of the present invention is the ability of such a device to provide a detachable printer for user selectable printing of fuel measurement and analysis reports.

A feature and advantage of the present invention is the ability of such a device to provide data storage and transfer, such as, for exemplary purposes only, a floppy or CD disk drive or memory card slot.

A feature and advantage of the present invention is the ability of such a device to enable user selectable analysis of a variety of fuel types and grades.

A feature and advantage of the present invention is the ability of such a device to enable user programming of function selection keys for alternate operation.

A feature and advantage of the present invention is the ability of such a device to enable quick-connection between a portable computer and a dipstick-style measuring stick.

A feature and advantage of the present invention is the ability of such a device to enable a user to rely on a series of prompts from an LCD window for input directions regarding tank dimensions and fuel type selections.

A feature and advantage of the present invention is the ability of such a device to enable a user to measure and analyze the contents of a plurality of fuel tanks in a plurality of locations without requiring more than one measurement device.

A feature and advantage of the present invention is the ability of such a device to enable tank measurement at remote locations.

A feature and advantage of the present invention is the ability of such a device to provide a portable storage tank measurement and analysis device that is completely self-contained and independently functioning.

A feature and advantage of the present invention is the ability of such a device to eliminate the reliance on the availability of electricity.

A feature and advantage of the present invention is the ability of such a device to eliminate the need for connection to a tank fitting.

A feature and advantage of the present invention is the ability of such a device to link to peripheral instruments, thereby enabling more complex remote analysis functions.

A feature and advantage of the present invention is the ability of such a device to incorporate analysis results from a peripheral instrument into on-board data files, enabling co-reporting thereof.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a portable, digital storage-tank measurement apparatus according to a preferred embodiment of the present invention, showing a portable computer unit removed from an elongated measurement rod.

FIG. 2 is a perspective view of a portable, digital storage-tank measurement apparatus according to a preferred embodiment of the present invention, showing a portable computer unit with a printer detached therefrom.

FIG. 3 is a perspective view of a portable, digital storage-tank measurement apparatus according to an alternate embodiment of the present invention, showing a memory card removed from a peripheral port.

FIG. 4 is a perspective view of a portable, digital storage-tank measurement apparatus according to a preferred embodiment of the present invention, showing an internal ball float within elongated rod.

FIG. 5a is a perspective view of a portable, digital storage-tank measurement apparatus according to a preferred embodiment of the present invention, showing a pair of valves located at a distal end of an elongated rod.

FIG. 5b is a side view of the portable, digital storage-tank measurement apparatus of FIG. 5a, showing an internal mechanism and a closed pair of valves located at the distal end of the elongated rod.

FIG. 5c is a side view of the portable, digital storage-tank measurement apparatus of FIG. 5a, showing an internal mechanism and an open pair of valves located at the distal end of the elongated rod.

FIG. 6a is a perspective view of a portable, digital storage-tank measurement apparatus according to an alternate embodiment of the present invention, showing a valve located on a side wall of an elongated rod.

FIG. 6b is a side view of the portable, digital storage-tank measurement apparatus of FIG. 6a, showing an internal mechanism and a closed valve located on a side wall of the elongated rod.

FIG. 6c is a side view of the portable, digital storage-tank measurement apparatus of FIG. 6a, showing an internal mechanism and an open valve located on a side wall of the elongated rod.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

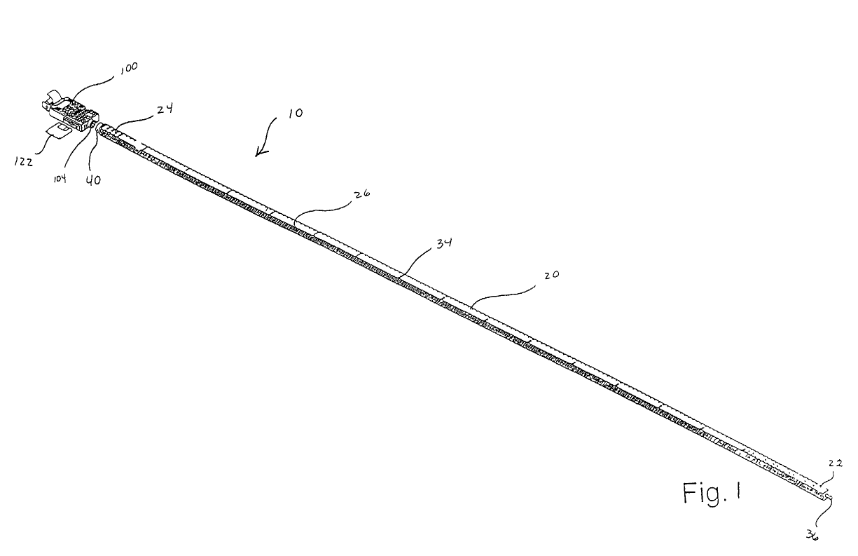

Referring now to FIG. 1, the present invention is a portable, digital storage tank measurement device 10 generally comprising elongated rod 20 and portable computer 100. Elongated rod 20 has distal end 22, proximal end 24, outer surface 26 and interior cavity 28 (not shown).

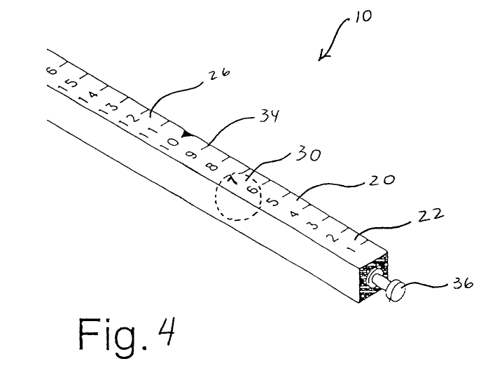

Preferably, interior cavity 28 has first ball float 30, represented in FIG. 4, carried therein, wherein the material of first ball float 30 has a density enabling first ball float 30 to position itself proximate to the surface of the fuel level within interior cavity 28, thus enabling measurement of the level of fuel thereby. Preferably, interior cavity 28 has second ball float 31 (not shown) carried therein, wherein the material of second ball float 31 has a density enabling second ball float 31 to pass through the fuel level to position itself proximate to the surface of the water level within interior cavity 28, thus enabling measurement of the level of water thereby.

Elongated rod 20 is preferably substantially transparent with outer surface 26 having markings 34 thereon, wherein markings 34 indicate the length of elongated rod 20 measured from distal end 22. The preferred transparency of elongated rod 20 enables a user to observe the position of first ball float 30 and second ball float 31 relative to measurement markings 34, thereby manually ascertaining the level or height of fluid within interior cavity 38 of elongated rod 20 at each liquid surface and, correspondingly, the level of fluids in a storage tank.

Electronic observation and reporting of the level of fluids within interior cavity 38 of elongated rod 20 is selectable. Elongated wire 32 (not shown) is preferably positioned within interior cavity 28, wherein the position of first ball float 30 relative to second ball float 31 and relative to distal end 22 of elongated rod 20, and the position of second ball float 31 relative to distal end 22 of elongated rod 20, is transmitted via elongated wire 32 and is received by portable computer 100. Transmission of the position of first ball float 30 and second ball float 31 via elongated wire 32 is preferably accomplished by incorporating electrical signal sensors and circuitry known in the art. While electrical signal transmission is the preferred method for communicating to portable computer 100 the position of first ball float 30 relative to second ball float 31 and to distal end 22 of elongated rod 20, and the position of second ball float 31 relative to distal end 22 of elongated rod 20, other appropriate methods also known in the art could be utilized such as, for exemplary purposes only, incorporating a magnetic element into first ball float 30 and second ball float 31 with a magnetostrictive sensor reporting thereon to portable computer 100. Moreover, the position of first ball float 30 could communicated relative to second ball float 31 only, or could be communicated relative to distal end 22 of elongated rod 20 only, wherein data regarding the position of second ball float 31 could be utilized to derive the approximate true level of liquid fuel in a storage tank.

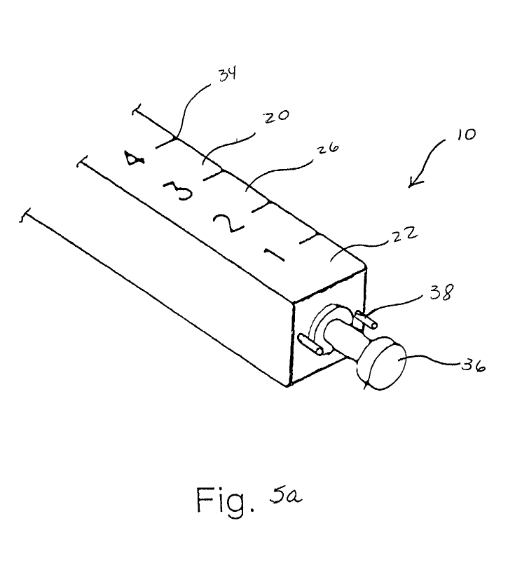

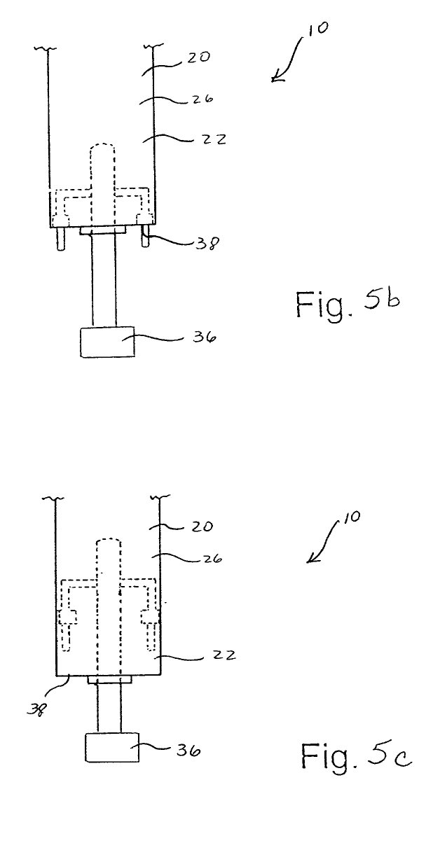

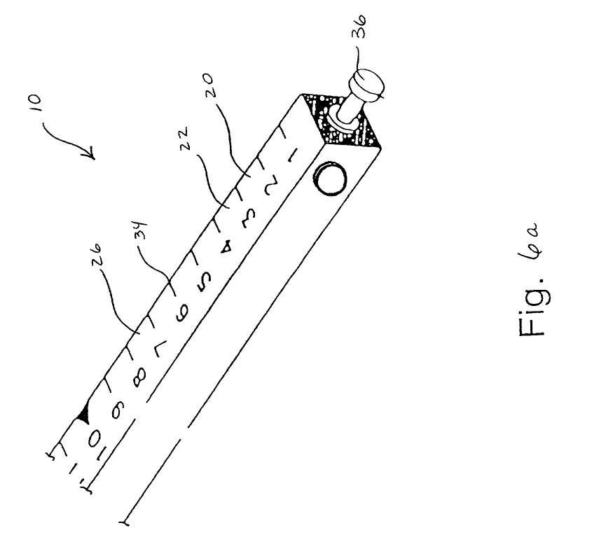

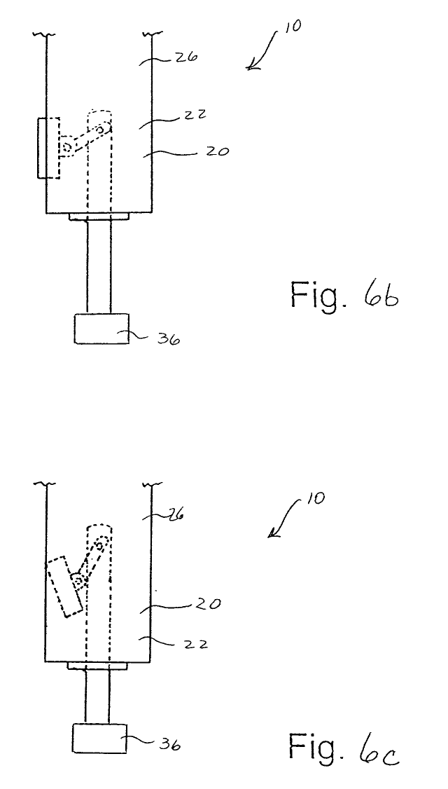

Preferably, activation of electronic observation and reporting function is initiated automatically in response to depression of pressure-sensitive activation foot 36, or upon user selection of on/off switch 102. Preferably, pressure-sensitive activation foot 36 is positioned at distal end 22 of elongated rod 20, extending outwardly therefrom. Valves 38, shown in FIGS. 5a, 5b, and 5c, are preferably provided proximal to distal end 22 of elongated rod 20, wherein depression of pressure-sensitive activation foot 36 opens valves 38 allowing liquid to enter interior cavity 28 of elongated rod 20. Preferably, pressure-sensitive activation foot 36 remains depressed, enabling the flow of fluid into and out of valves 38, until user-initiated action returns foot 36 to the extended position, thereby closing valves 38. By enabling valves 38 to remain open, fluid is free to drain from interior cavity 28 of elongated rod 20 as it is removed from a storage tank or vessel. While it is preferred that valves 38 are positioned proximal to distal end 22 of elongated rod 20, one skilled in the art would readily recognize that valves 38 could be provided on a side wall of elongated rod 20, as seen in FIGS. 6a, 6b and 6c. Moreover, while the preferred functional design of valves 38 is demonstrated and described in the Figures, one skilled in the art would readily recognize that valves 38 could function to allow the ingress and egress of liquid from elongated rod 20 by any means known in the art without departing from the anticipated scope or novelty of the present invention.

Preferably, proximal end 24 of elongated rod 20 carries female peripheral port 40, wherein female peripheral port 40 is known in the art and enables physical and communicative connection of elongated rod 20 and portable computer 100, whereby measurement data is transmitted therethrough.

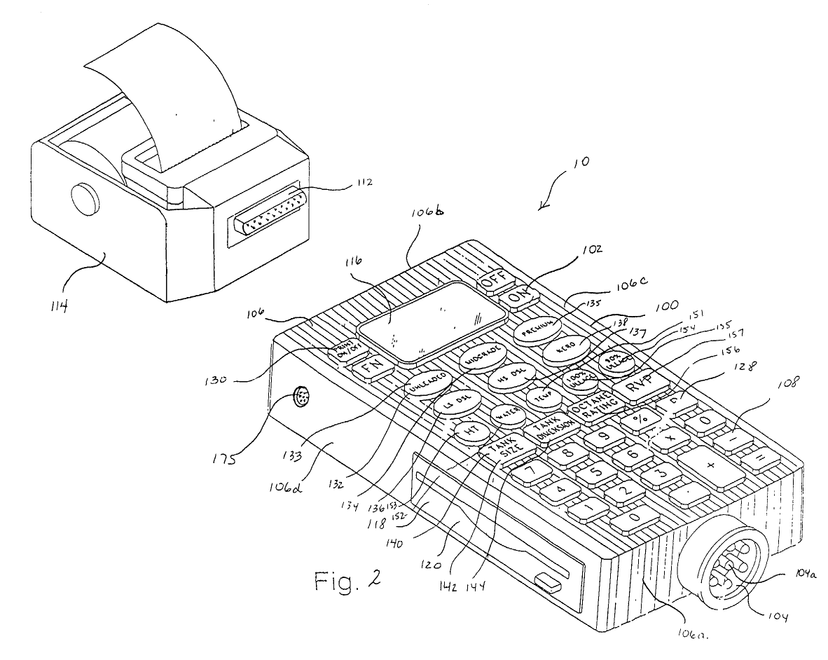

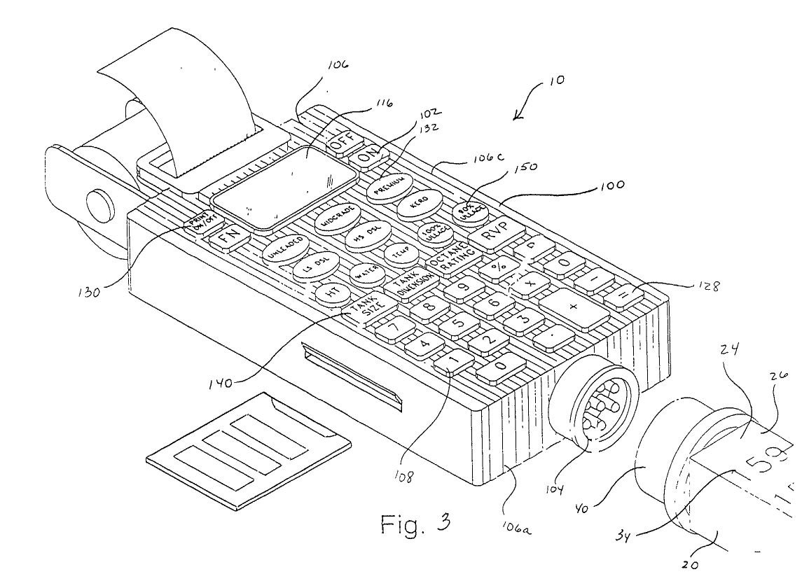

Portable computer unit 100 preferably has a male peripheral port 104, wherein female peripheral port 40 of elongated rod 20 mates therewith. One skilled in the art would readily recognize that, alternatively, male peripheral port 104 could be female and female peripheral port 40 could be male, wherein physical and communicative connection would remain. As best seen in FIGS. 2 and 3, peripheral port 104 of portable computer unit 100 is preferably positioned proximate to first end 106a of unit casing 106. Preferred positioning of peripheral port 104 enables upright positioning of portable computer unit 100 when secured to peripheral port 40 of elongated rod 20, thereby providing easy user access to keypad 108 during the measurement process.

Portable computer unit 100 preferably has female peripheral port 110 (not shown), wherein male peripheral port 112, best seen in FIG. 2, of detachable printer 114 mates therewith. One skilled in the art would readily recognize that, alternatively, male peripheral port 112 could be female and female peripheral port 110 could be male, wherein physical and communicative connection would remain. Preferably, peripheral port 110 of portable computer unit 100 is positioned proximate to second end 106b of unit casing 106. Preferred positioning of peripheral port 112 enables upright positioning of detachable printer 114 when secured to peripheral port 110 of portable computer unit 100, thereby providing easy user access thereto and removal of printed results therefrom.

Display window 116 is preferably provided on upper surface 106c of unit casing 106 of portable computer unit 100 for displaying operation instructions and results. Preferably, display window 116 is liquid crystal display (LCD). However, although LCD is the preferred type of display window 116, alternate types of display windows could be utilized such as, for exemplary purposes only, field emission display (FED), cathode ray tube (CRT), vacuum fluorescent display (VFD), plasma display panel (PDP), or other visual display screen or window.

Data storage, retrieval and transfer device 118 is preferably integrated with portable computer unit 100, wherein user access thereto is provided preferably through side wall 106d of unit casing 106. While positioning proximal to side wall 106d of unit casing 106 of portable computer unit 100 is preferred, data storage, retrieval and transfer device 113 could be positioned at any functional location within portable computer unit 100 with access thereto provided through unit casing 106. Preferably, data storage, retrieval and transfer device 118 is disk drive 120. One skilled in the art would readily recognize that disk drive 120 may be configured to read and transfer data to and from a floppy disk 122, compact disk (cd) (not shown), magnetic tape or other digital data recording accessory.

Preferably, data storage, retrieval and transfer device 118 is configured to portable data storage module 121 (not shown), wherein portable data storage module 121 is preferably a floppy disk 122, compact disk (cd) (not shown), magnetic tape or other portable data module capable of retaining machine and user-accessible dimensional data specifics for at least one storage tank. Preferably, portable data storage module 121 is selectively utilized to eliminate manual user-input of tank dimensions. Moreover, in the preferred form, portable data storage module 121 includes machine and user-accessible data on tank contents such as, for exemplary purposes only, quantities delivered thereto and dispensed therefrom, thereby enabling ongoing tracking, monitoring and reporting of tank data as well as ullage calculation and reporting.

Preferably, portable computer unit 100 is battery powered and rechargeable. Keypad 108 preferably includes a plurality of keys 128 enabling a user to initiate and perform a plurality of functions. In the preferred form, keys 128 include numerals and basic mathematical functions, thereby enabling portable computer unit 100 to perform as a full function calculator. Keypad 108 preferably includes printer selection key 130 for user operation of detachable printer 114 and on/off switch 102 enabling user manual control over power to portable computer unit 100.

Keypad 108, best viewed in FIG. 2, preferably includes target fuel type keys 132 including unleaded 133, midgrade 134, premium 135, low sulfur diesel 136, high sulfur diesel 137 and kerosene 138. One skilled in the art would readily recognize that, while the foregoing are the preferred target fuel types, other fuels, liquids or vapors could be included and analyzed. Selection of target fuel type keys 132 enable a user to communicate the type of fuel to be analyzed to portable computer unit 100 and, preferably, to peripheral device 200 (not shown).

Keypad 108 preferably includes tank specification keys 140 including tank size 142 and tank dimension 144. Selection of tank specification keys 140 enables a user to communicate parameters indicating the maximum storage capacity of a tank, wherein the contents of the tank are to be analyzed. Preferably, selection of tank specification keys 140 also enables retrieval of tank specific dimensional data from data storage, retrieval and transfer device 118, thus enabling a user to avoid manual entry thereof.

Keypad 108 preferably includes analysis selection keys 150 including temperature 151, water 152, HT (height) 153, 90% ullage 154, 100% ullage 155, octane rating 156 and vapor pressure 157. Selection of temperature key 151 initiates display of temperature readings of tank contents, wherein temperature is preferably measured within interior cavity 38 of elongated rod 20 by temperature probe 32a (not shown) of elongated wire 32. One skilled in the art would readily recognize that while positioning of temperature probe 32a within interior cavity 38 of elongated rod 20 is preferred, other positions could be utilized such as, for exemplary purposes only, mounting of temperature probe 32a on outer surface 26 of elongated rod 20 or any other location relative to elongated rod 20, wherein electronic communication of the temperature of the analyzed fluid is transmitted via elongated wire 32 and is received by portable computer 100. In addition, more than one temperature probe 32a could be provided to enable testing at a plurality of depths within a test tank. Moreover, one skilled in the art would readily recognize that alternative methods of ascertaining fluid temperature could be utilized such as, for exemplary purposes only, known infrared or ultrasonic temperature testing and reporting methods, wherein additional components such as an infrared source and/or a transducer could be incorporated into portable, digital storage tank measurement device 10.

Selection of HT key 153 initiates display of height readings of liquid tank contents, wherein height is preferably measured within interior cavity 38 of elongated rod 20 by the position of first ball float 30 relative to distal end 22 of elongated rod 20 and is preferably transmitted via elongated wire 32 and is received by portable computer 100. Height measurement may also incorporate positional data of second ball float 31 relative to distal end 22 of elongated rod 20, wherein a user desires to differentiate between total liquid height within a tank and liquid height contributed by fuel only. Height measurement data, temperature data and tank specification data, wherein tank data may be user-input or obtained from portable data storage module 121, are utilized by portable computer 100 to perform calculations to ascertain the volume of liquid within the analyzed tank.

User selection of 90% ullage 154 or 100% ullage 155 initiates calculating and reporting thereon, wherein generated liquid volume data is further utilized and compared to specific tank data from portable data storage module 121, including quantities delivered thereto and dispensed from a specific target tank, thereby enabling a user to rely on ullage reports to quickly ascertain appropriate volumes for delivery to the target tank.

Selection of RVP key 157 and octane rating key 156 preferably retrieves appropriate data from known peripheral device 200, wherein known peripheral device 200 conducts fuel characterization via infrared analysis of a fuel sample and feeds data to portable computer unit 100 through USB port 175.

Preferably, USB port 175 of portable computer unit 100, best seen in FIG. 2, also receives a known sniffer device 202 (not shown), wherein sniffer device 202 can communicatively link with portable computer unit 100 to enable ground level vapor detection, analysis and reporting thereon.

Selection of water key 152 initiates analysis and display of percentage water content of tank liquid. Preferably, water concentration data is collected within interior cavity 38 of elongated rod 20, wherein electronic communication of the water data of the analyzed fluid is transmitted via elongated wire 32 and is received by portable computer 100. Positional data for second ball float 31 is utilized, along with tank specifications, by portable computer 100 to calculate and report water content.

One skilled in the art would readily recognize that although it is preferred that independent water content analysis capabilities are enabled by portable, digital storage-tank measurement device 10, wherein peripheral device 200 is connected thereto for infrared analysis of fuel components, water content analysis results may be provided thereby, enabling portable, digital storage-tank measurement device 10 to report tank water content without performing independent analysis thereof. Thus, in an alternate embodiment portable, digital storage-tank measurement device 10 could be manufactured without independent water content analysis capabilities.

In an alternate embodiment, internal sample capillary 50 (not shown) could be provided within interior cavity 38 of elongated rod 20, wherein a liquid sample could be transported thereby from distal end 22 of elongated rod 20 to proximal end 24 thereof. Female peripheral port 40 of proximal end 24 of elongated rod 20 could incorporate internal sample capillary 50 (not shown), whereby collected fluid present within internal sample capillary 50 could pass to male peripheral port 104 of portable computer unit 100 when engaged therewith. Male peripheral port 104 of portable computer unit 100 could have capillary reception port 104a, wherein disposable port liners (not shown) could be user-provided to prevent contamination of portable computer unit 100 from liquid samples. A liquid sample collected for analysis could be drawn via capillary action into lined capillary reception port 104a, wherein infrared light source 160 (not shown) and infrared detector 162 (not shown) could be provided and utilized to obtain absorbance data, and wherein known absorbance characteristics for disposable port liners could be factored into calculations, thereby enabling the derivation of water concentration, the octane rating and the reid vapor pressure of the fluid sample by portable computer unit 100.

In an alternate embodiment, portable computer unit 100 could be provided with a removable memory card or stick for additional capacity.

In an alternate embodiment, portable computer unit 100 could have a clock and/or timer capable of continuous expression in display window 116.

In an alternate embodiment, elongated rod 20 could be telescoping or folding to enable compact transportability.

In an alternate embodiment, interior cavity 28 of elongated rod 20 could incorporate known sonic transmission and reception apparatus, wherein fluid level could be deduced from data generated thereby.

In an alternate embodiment, elongated rod 20 could carry a plurality of sensors thereon, wherein each sensor responds to the presence of fuel at a given height relative to the length of elongated rod 20 and indicates the height to the user by illuminating a light.

In an alternate embodiment, portable computer unit 100 could have audible indicators, wherein results could be announced to a user.

In an alternate embodiment, portable computer unit 100 could be solar powered.

In an alternate embodiment, printer 114 could be permanently mounted on portable computer unit 100.

In an alternate embodiment, elongated rod 20 could have a plurality of temperature sensors provided thereon, wherein a plurality of depths could be tested and reported.

In an alternate embodiment, a liquid sample collected via valves 38 proximal to distal end 22 of elongated rod 20 could enter a removable sample chamber, wherein the sample chamber could then be placed into portable computer unit 100, or an alternative independent analysis unit, such as peripheral device 200, for further characterization thereof.

In use, portable, portable computer unit 100 is secured to elongated rod 20 and elongated rod 20 is submerged inside of a selected fuel tank. Pressure sensitive activation foot 36 is depressed by the floor of the tank, thereby initiating function of portable computer unit 100 and collection of a sample through valves 38. The volume of liquid may be read directly from elongated rod 20, or the user may rely on a series of prompts from display window 116, inputting tank dimensions and selecting a fuel type to be analyzed, wherein portable, digital storage tank measurement device 10 can detect, calculate and report volume, water content, temperature and ullage. A user may link to a peripheral analysis device for measurement of octane, reid vapor pressure or for analysis ground level vapors, wherein portable, digital storage tank measurement device 10 can report thereon. A user may utilized printer 114 to print results and/or may store the results on portable, digital storage unit 122 for subsequent analysis at another location.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A portable, digital storage-tank measurement device, comprising:
an elongated rod having a fluid measurement means, sample collection means and data transmission means;
an activation means;
a computer module, said computer module communicatively and removably carried by said elongated rod, said computer module activated by said activation means, said computer module having a visual display and said computer module having a keyboard user-interface;
a printer module, said printer module communicatively and removably carried by said computer module;
a data storage means, said data storage means carried by said computer module;
a data transport means, said data transport means configured to receive data from said data storage means and transport said data to an external location; and
a portable power source, said portable power source carried by said computer module, providing power thereto.

2. The portable, digital storage-tank measurement device of claim 1, wherein said activation means is a pressure sensitive button.

3. The portable, digital storage-tank measurement device of claim 1, wherein said activation means is a user-activated switch.

4. The portable, digital storage-tank measurement device of claim 1, wherein said data storage means is a floppy disk drive and said data transport means is a floppy disk.

5. The portable, digital storage-tank measurement device of claim 1, wherein said data storage means is a CD drive and said data transport means is a compact disc.

6. The portable digital storage-tank measurement device of claim 1, wherein said data storage means is a tape drive and said data transport means is a tape.

7. The portable digital storage-tank measurement device of claim 1, wherein said data storage means carries retrievable and accessible tank specification data.

8. The portable digital storage-tank measurement device of claim 1, wherein said fluid measurement means is a ball float mechanism.

9. The portable digital storage-tank measurement device of claim 1, wherein said fluid measurement means is sonar apparatus.

10. The portable digital storage-tank measurement device of claim 1, wherein said elongated rod is substantially transparent.

11. The portable digital storage-tank measurement device of claim 1, wherein said sample collection means of said elongated rod is at least one valve, wherein said valve is operated via said activation means.

12. The portable digital storage-tank measurement device of claim 11, wherein said sample collection means further comprises a capillary, wherein said capillary transports a sample to said computer module, and wherein said computer module has an infrared source, detector and a sample port, said sample port dimensioned to receive at least one sample port protective liner.

13. The portable digital storage-tank measurement device of claim 1, wherein said computer module further comprises an audible display.

14. The portable digital storage-tank measurement device of claim 1, wherein said portable power source is at least one battery.

15. The portable digital storage-tank measurement device of claim 14, wherein said at least one battery is rechargeable.

16. The portable digital storage-tank measurement device of claim 1, wherein said portable power source is at least one solar cell.

17. The portable digital storage-tank measurement device of claim 1, wherein said computer module further comprises at least one USB port.

18. The portable digital storage-tank measurement device of claim 1, wherein said data transmission means is an elongated wire, said elongated wire carried by said elongated rod and said elongated wire enabling transmission of data to said computer module.

19. The portable digital storage-tank measurement device of claim 1, wherein said visual display of said computer module is liquid crystal display (LCD).

20. The portable digital storage-tank measurement device of claim 1, wherein said computer module has a water-resistant casing.

21. The portable digital storage-tank measurement device of claim 1, wherein said keyboard user-interface of said computer module comprises preprogrammed selectable keys for target fuel types, tank parameters and target analysis types.

22. The portable digital storage-tank measurement device of claim 21, wherein said preprogrammed selectable keys for target fuel types include selections for analyzing unleaded, midgrade, premium, low sulfur diesel, high sulfur diesel and kerosene, wherein said preprogrammed selectable keys for tank parameters include selections for inputting tank size and tank dimension, and wherein said preprogrammed selectable keys for target analysis types include selections for analysis and reporting of temperature, water, height (HT), 90% ullage, 100% ullage, octane rating and vapor pressure.

23. The portable digital storage-tank measurement device of claim 17, wherein a vapor sniffer is communicatively linked to said USB port.

24. The portable digital storage-tank measurement device of claim 17, wherein a portable infrared analysis instrument is communicatively linked to said USB port.

25. The portable digital storage-tank measurement device of claim 1, further comprising a peripheral slot for removably carrying a peripheral memory card.

26. The portable digital storage-tank measurement device of claim 1, wherein said elongated rod is telescoping.

27. The portable digital storage-tank measurement device of claim 1, wherein said visual display includes a time keeping display.

28. The portable digital storage-tank measurement device of claim 1, further comprising a wireless communicator enabling communication of data from said computer module to a receiver.

29. A portable storage-tank measurement device, comprising:
a substantially transparent, elongated rod having a ball float measurement mechanism with at least one ball float, at least one user-activated fluid intake-valve, a sample transport vessel and a data transmission line;
a pressure-sensitive activator foot;
a computer module having a water-resistant casing, said computer module communicatively and removably carried by said elongated rod, receiving data transmitted by said data transmission line, said computer module activated by said pressure-sensitive foot, said computer module having a liquid crystal display, said computer module having a keyboard user-interface, said keyboard user-interface having keys for selecting target fuel types, tank parameters and analysis goals, and said computer module having a USB port;
a printer module, said printer module communicatively and removably carried by said computer module;
a data storage drive, said data storage drive carried by said computer module;
a removable data storage disk, said data storage disk configured to transmit to and receive data from said data storage drive, said data including tank specifications and contents analysis data; and
at least one battery power source carried by said computer module.

30. The portable storage-tank measurement device of claim 29, further comprising said computer module having a sample transport vessel receptacle, said computer module having an infrared source and an infrared detector, said sample transport vessel receptacle positioned therebetween enabling infrared analysis thereof,

31. The method of analyzing the liquid contents of a storage tank, comprising the steps of:
a) obtaining a portable digital storage-tank measurement device having a substantially transparent, elongated rod having a ball float measurement mechanism, at least one user-activated fluid intake-valve, a sample transport vessel and a data transmission line; a computer module having a water-resistant casing, said computer module communicatively and removably carried by said elongated rod, receiving data transmitted by said data transmission line, said computer module activated by a pressure-sensitive foot, said computer module having a liquid crystal display, said computer module having a keyboard user-interface, said keyboard user-interface having keys for selecting target fuel types, tank parameters and analysis goals, and said computer module having at least one USB port; a printer module, said printer module communicatively and removably carried by said computer module; a data storage drive, said data storage drive carried by said computer module; a removable data storage disk, said data storage disk configured to transmit to and receive data from said data storage drive; and at least one battery power source carried by said computer module;
b) placing said elongated rod into a storage tank;
c) depressing said pressure-sensitive foot, thereby activating said computer module and initiating sample collection;
d) selecting target fuel types, receiving tank parameters and selecting analysis goals;
e) reading analysis results on said visual display.

32. The method of analyzing the liquid contents of a storage tank of claim 31, further comprising the step of:
f) printing analysis results with said printer module.

33. The method of analyzing the liquid contents of a storage tank of claim 32, further comprising the step of:
g) storing analysis results with said data storage drive.
